(19) United States
(12) Patent Application Publication
(10) Pub. No.: US 2013/0129572 A1
(43) Pub. Date: May 23, 2013

(54) HYDROGEN-GENERATING EQUIPMENT

(71) Applicants: Yu-Wen Lu, HSINCHU COUNTY (TW); Chan-Li Hsueh, HSINCHU COUNTY (TW); Jie-Ren Ku, HSINCHU COUNTY (TW); Po-Kuei Chou, HSINCHU COUNTY (TW); Fang-Hei Tsau, HSINCHU COUNTY (TW)

(72) Inventors: Yu-Wen Lu, HSINCHU COUNTY (TW); Chan-Li Hsueh, HSINCHU COUNTY (TW); Jie-Ren Ku, HSINCHU COUNTY (TW); Po-Kuei Chou, HSINCHU COUNTY (TW); Fang-Hei Tsau, HSINCHU COUNTY (TW)

(21) Appl. No.: 13/677,308

(22) Filed: Nov. 15, 2012

(30) Foreign Application Priority Data
Nov. 18, 2011 (CN) 201110378869.6

(51) Int. Cl. C01B 3/56

(52) U.S. Cl. CPC C01B 3/56
USPC 422/162

(57) ABSTRACT

A hydrogen-generating equipment including a hydrogen-generating device and a hydrogen-purifying device is provided. The hydrogen-generating device is capable of generating a hydrogen-gas, a water-vapor mixed in the hydrogen-gas and a toxic-gas mixed in the hydrogen-gas. The hydrogen-purifying device includes a water-vapor filter unit and a toxic-gas filter unit. The hydrogen-gas passes through the water-vapor filter unit to remove the water-vapor mixed in the hydrogen-gas. The toxic-gas filter unit includes a filtering assembly. The surface of the filtering assembly has a plurality of hydroxyls. After the hydrogen-gas passes through the water-vapor filter unit, the hydrogen-gas passes through the toxic-gas filter unit, and the toxic-gas mixed in the hydrogen-gas reacts with a plurality of hydroxyls on a surface of the filtering assembly to remove the toxic-gas.

### CROSS-REFERENCE TO RELATED APPLICATION

This application claims the priority benefit of China application serial no. 201110378869.6, filed on Nov. 18, 2011. The entirety of the above-mentioned patent application is hereby incorporated by reference herein and made a part of this specification.

### BACKGROUND OF THE INVENTION

1. Field of the Invention

The invention generally relates to a gas-generating equipment, and more particularly, to a hydrogen-generating equipment.

2. Description of Related Art

The fuel cell (FC) is a power generating device which coverts chemical energy into electric energy. Compared with conventional power generating methods, the fuel cell has advantages such as low pollution, low noise, high energy density, and relatively high energy conversion efficiency and is a clean energy source with a promising future. The fuel cell could be applied in various fields, including portable electronic products, home power generating systems, transportation vehicles, military facilities, aerospace industry, and small power generating systems.

Different fuel cells are applied in different markets considering their working principles and operating environments. Among others, the proton exchange membrane fuel cell (PEMFC) and direct methanol fuel cell (DMFC) are mainly used as movable power sources. The two types of fuel cells both use proton exchange membranes to implement the proton conduction mechanism, and are fuel cells that could be started at a low temperature. The operating principle of the PEMFC is as follows: when hydrogen is oxidized on an anode catalyst layer, hydrogen ions (H+) and electrons (e−) are produced (the PEMFC principle). The hydrogen ions are transmitted to a cathode by a proton conduction membrane, and the electrons are transferred to a load by an external circuit, perform work, and then transmitted to the cathode. At this time, oxygen supplied to the cathode end and the hydrogen ions and electrons undergo reduction on a cathode catalyst layer, and water is produced.

It is a common hydrogen-generating method of a fuel cell by means of the reaction between a solid fuel and an acid water-solution to generate hydrogen. However, the major disadvantage by using the acid water-solution serving as a reactant rests in generating toxic minor products. For example, a solid sodium borohydride (NaBH₄) and a citric acid (C₆H₈O₇) water-solution may respectively serve as a solid fuel and an acid water-solution for reaction, and diborane (B₂H₆) gas is a product of the reaction. Diborane(B₂H₆) gas is harmful for human body and people who inhale the diborane gas with too high concentration (higher than 0.1 ppm) may be at the risk of cancer.

R.O.C. Patent Application Publication No. 200809125 discloses that hydrogen is generated by using sodium borohydride powder to react with water, alcohols or diluted acid or other liquid fuels. R.O.C. Patent No. I319638 discloses a fuel supply, including a fuel container and an impurities-removing box. R.O.C. Patent Application Publication No. 200500295 discloses a cleaning agents for removing harmful hydride ingredients at room temperature through chemical adsorption. U.S. Patent Application Publication No. 20080113249 discloses that a fuel cell system with a filter to remove impurities. U.S. Patent Application Publication No. 20080044696 discloses that a hydrogen-generating cartridge employing a filter for purifying hydrogen-gas. U.S. Pat. No. 4,532,115 discloses that a method of removing toxic gas by using an aluminide U.S. Pat. No. 4,743,435, U.S. Pat. No. 4,996,030 and U.S. Pat. No. 4,910,001 disclose a method of filtering out diborane gas by using aluminide.

### SUMMARY OF THE INVENTION

Accordingly, the invention is directed to a hydrogen-generating equipment capable of effectively filter out a toxic gas mixed in a hydrogen-gas.

Other objectives and advantages of the invention should be further indicated by the disclosures of the invention, and omitted herein for simplicity.

To achieve one of, a part of or all of the above-mentioned objectives, or to achieve other objectives, an embodiment of the invention provides a hydrogen-generating equipment. The hydrogen-generating equipment includes a hydrogen-generating device and a hydrogen-purifying device. The hydrogen-generating device is capable of generating a hydrogen-gas, a water-vapor mixed in the hydrogen-gas and a toxic-gas mixed in the hydrogen-gas. The hydrogen-purifying device includes a water-vapor filter unit and a toxic-gas filter unit, wherein the hydrogen-gas passes through the water-vapor filter unit to remove the water-vapor mixed in the hydrogen-gas. The toxic-gas filter unit includes a filtering assembly, wherein a surface of the filtering assembly has a plurality of hydroxyls, after the hydrogen-gas passes through the water-vapor filter unit and when the hydrogen-gas passes through the toxic-gas filter unit, the toxic-gas mixed in the hydrogen-gas reacts with the plurality of hydroxyls to remove the toxic-gas.

Based on the description above, in the above-mentioned embodiments of the invention, the filtering assembly uses the hydroxyls on the surface thereof to conduct a chemical reaction with the toxic-gas so as to filter out the toxic-gas mixed in the hydrogen-gas, which could avoid the adsorption-saturation situation occurring during filtration in a physical adsorption way and could improve the filtering effect. In addition, the hydrogen-gas generated by the hydrogen-generating device would pass through the water-vapor filter unit and then pass through the filtering assembly of the toxic-gas filter unit, which could avoid reducing the reaction efficiency between the hydroxyls and the toxic-gas due to excess water-vapor adsorbed by the surface of the filtering assembly.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a hydrogen-generating equipment used in a fuel cell according to an embodiment of the invention.

FIG. 2 is a schematic diagram of the hydrogen-purifying device of FIG. 1.

FIG. 3 is a schematic diagram illustrating a reaction between the filtering assembly of FIG. 2 and a toxic-gas.

FIG. 4 is a schematic diagram of the hydrogen-generating device of FIG. 1.

FIG. 5 is a schematic diagram illustrating a reaction between a filtering assembly and a toxic-gas according to another embodiment of the invention.

FIG. 6 is a partial cross-sectional diagram of the hydrogen-generating device of FIG. 1.

FIG. 7 is a schematic diagram of a water-vapor filter unit according to yet another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

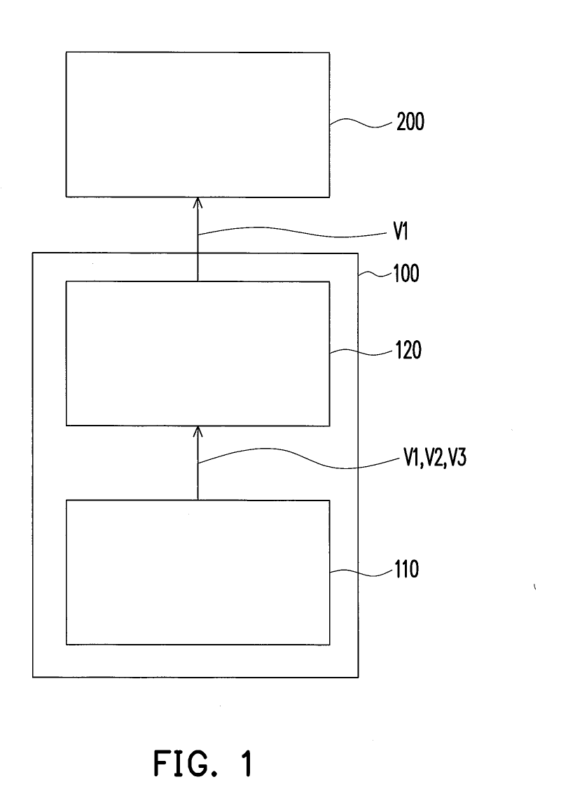

FIG. 1 is a schematic diagram of a hydrogen-generating equipment used in a fuel cell according to an embodiment of the invention. Referring to FIG. 1, a hydrogen-generating equipment 100 of the embodiment could be used in a fuel cell 200 and includes a hydrogen-generating device 110 and a hydrogen-purifying device 120. The hydrogen-generating device 110 is capable of generating a hydrogen-gas V1, a water-vapor V2, and a toxic-gas V3 mixed in the hydrogen-gas V1.

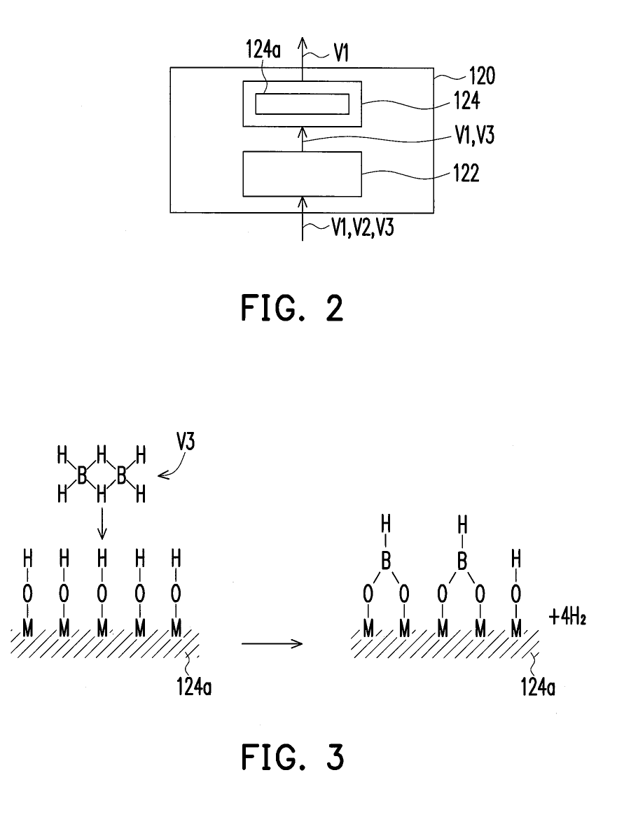

FIG. 2 is a schematic diagram of the hydrogen-purifying device of FIG. 1. Referring to FIG. 2, the hydrogen-purifying device 120 of the embodiment includes a water-vapor filter unit 122 and a toxic-gas filter unit 124. The toxic-gas filter unit 124 includes a filtering assembly 124a. Prior to passing through the toxic-gas filter unit 124, the hydrogen-gas V1 passes through the water-vapor filter unit 122 to remove the water-vapor V2 mixed in the hydrogen-gas V1.

FIG. 3 is a schematic diagram illustrating the reaction between the filtering assembly of FIG. 2 and the toxic-gas. Referring to FIG. 3, the toxic-gas V3 of the embodiment is, for example, diborane (B₂H₆). A surface of the filtering assembly 124a has a plurality of hydroxyls (—OH). After the hydrogen-gas V1 passes through the water-vapor filter unit 122 to filter out the water-vapor V2, the hydrogen-gas V1 would pass through the toxic-gas filter unit 124. At the time, the toxic-gas V3 mixed in the hydrogen-gas V1 reacts with the plurality of hydroxyls to form boron-oxygen bond (B—O) as shown by FIG. 3 so as to remove the toxic-gas V3. The hydrogen-gas V1 purified by the water-vapor filter unit 122 and the toxic-gas filter unit 124 is guided to the fuel cell 200 for use.

Under the above-mentioned configuration, the filtering assembly 124a uses the hydroxyls on the surface thereof to conduct a chemical reaction with the toxic-gas V3 to filter out the toxic-gas V3 mixed in the hydrogen-gas V1. Thus, the adsorption-saturation situation occurring during filtration in a physical adsorption way could be avoided and the filtering effect is improved. In addition, the hydrogen-gas V1 generated by the hydrogen-generating device 110 would pass through the water-vapor filter unit 122 and then pass through the filtering assembly 124a of the toxic-gas filter unit 124 so as to avoid reducing the reaction efficiency between the hydroxyls and the toxic-gas due to too much water-vapor adsorbed by the surface of the filtering assembly.

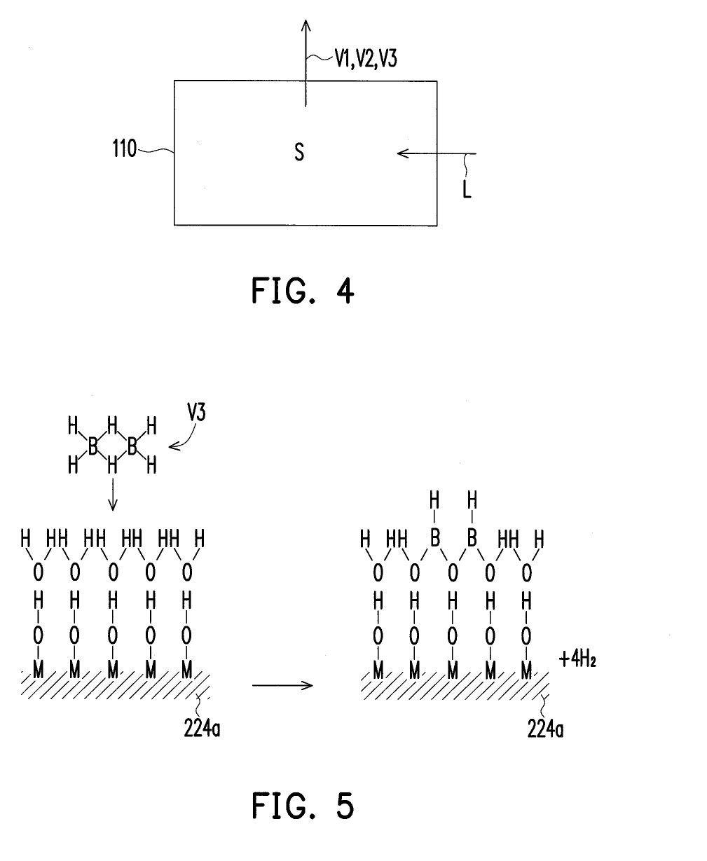

FIG. 4 is a schematic diagram of the hydrogen-generating device of FIG. 1. Referring to FIG. 4, in the embodiment, the hydrogen-gas V1, the water-vapor V2 mixed in the hydrogen-gas V1 and the toxic-gas V3 mixed in the hydrogen-gas V1 are generated by, for example, the reaction between a solid reactant S and an acid water-solution L.

The solid reactant S could be a solid hydride or a mixture of a solid hydride and a solid catalyst, and the solid hydride could be borohydride, nitrogen hydrides, hydrocarbons, metal hydride, boron nitrogen hydride, boron hydrocarbons, nitrogen hydrocarbons, metal boron hydride, metal nitrogen hydride, metal hydrocarbons, metal boron nitrogen hydrides, metal boron hydrocarbons, metal carbon nitrogen hydride, boron nitrogen hydrocarbons, metal boron nitrogen hydrocarbons or a combination of the above ingredients. For example, the solid hydride could include sodium borohydride (NaBH₄), sodium hydride (NaH), lithium boron hydride (LiBH₄), lithium hydride (LiH), calcium hydride (CaH₂), calcium borohydride (Ca(BH₄)₂), magnesium borohydride (MgBH₄), potassium borohydride (KBH₄), aluminum borohydride (Al(BH₄)₃), ammonia borane (H₃BNH₃), diborane diammoniate (H₂B(NH₃)₂BH₄), polyaminoborane ((NH₂BH₂)n), borazine (B₃N₃H₆), borane-morpholine complex (MPB), borane-tetrahydrofuran complex (BH₃/THF), diborane or other boranes. In addition, the above-mentioned solid catalyst includes solid acid, salts containing ruthenium (Ru), cobalt (Co), nickel (Ni), copper (Cu), iron (Fe) or a solid catalyst made by using the ions thereof.

The acid water-solution L could include water-solution of organic acids such as citric acid, malic acid, oxalic acid, acetic acid, tartaric acid, succinic acid, lactic acid and water-solution of inorganic acids such as hydrochloric acid, sulfuric acid or nitric acid.

The filtering assembly 124a in FIGS. 2 and 3 is, for example but not limited to, a porous structure. The material of the filtering assembly 124a could be, for example, activated carbon, alumina (Al₂O₃), zeolite, molecular sieve, or a combination of at least two of activated carbon, alumina, zeolite, and molecular sieve. The hydroxyls are provided by, for example, the filtering assembly 124a itself, which the invention is not limited to. In following, the reaction is explained in association with FIG. 5. FIG. 5 is a schematic diagram illustrating the reaction between a filtering assembly and the toxic-gas according to another embodiment of the invention. Referring to FIG. 5, the surface of the filtering assembly 224a has single-layer of water molecules and the plurality of hydroxyls are provided by the water molecules in a single-layer. Similarly to FIG. 3, the toxic-gas V3 (diborane) reacts with the plurality of hydroxyls of the water molecules in single-layer to form boron-oxygen bond (B—O) so as to remove the toxic-gas V3 as shown by FIG. 5.

In the embodiment of FIG. 2, the water-vapor filter unit 122 may include absorbent cotton fiber mixed with an absorbent organic material or mixed with an absorbent inorganic material. The absorbent organic material is, for example, an absorbent macromolecule material such as polyacrylate, polyvinyl alcohol (PVA), ethylene vinylacetate copolymer (EVA copolymer), polyurathane (PU), polyethylene oxide, starch branch copolymers, rubber mixture or a combination of the above-mentioned materials. The absorbent inorganic material is, for example, aluminosilicate crystal, calcium chloride (CaCl₂), calcium oxide (CaO), anhydrous cobalt chloride (CoCl₂), anhydrous copper sulfate (CuSO₄), silica gel, clay or a combination of the above-mentioned materials.

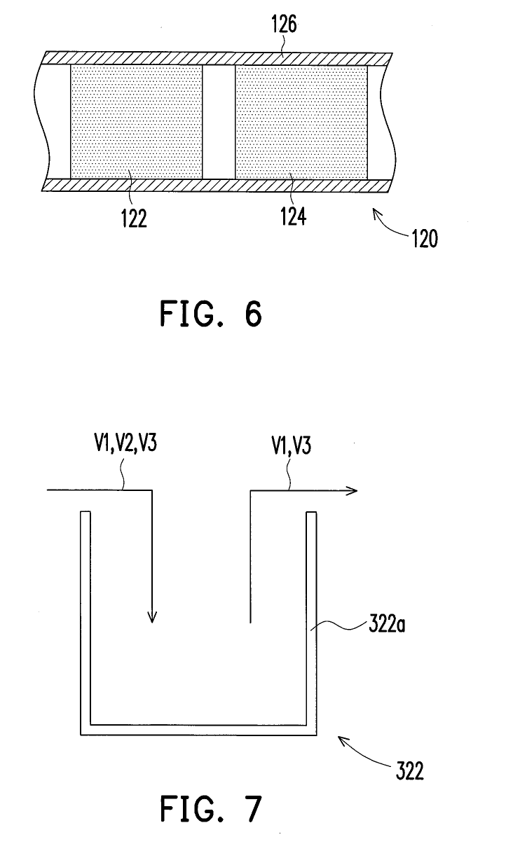

FIG. 6 is a partial cross-sectional diagram of the hydrogen-generating device of FIG. 1. Referring to FIG. 6, the hydrogen-purifying device 120 of the embodiment includes a tube structure 126, a water-vapor filter unit 122 and a toxic-gas filter unit 124 disposed in the tube structure 126. The hydrogen-gas V1 (shown in FIG. 1) passes through the tube structure 126 to sequentially pass through the water-vapor filter unit 122 and the toxic-gas filter unit 124. In other embodiments, the hydrogen-purifying device 120 could have other structures with appropriate shapes, which the invention is not limited to. In addition, the invention does not limit the form of the water-vapor filter unit 122, as shown by, for example, FIG. 7.

FIG. 7 is a schematic diagram of a water-vapor filter unit according to yet another embodiment of the invention. Referring to FIG. 7, a water-vapor filter unit 322 includes a cooling assembly 322a, the hydrogen-gas V1, the water-vapor V2 and the toxic-gas V3 are cooled by the cooling assembly 322a, which condenses the water-vapor V2 mixed in the hydrogen-gas V1 so as to remove the water-vapor V2 in the hydrogen-gas V1.

In summary, in the above-mentioned embodiments of the invention, the filtering assembly uses the hydroxyls on the surface thereof to conduct a chemical reaction with the toxic-gas so as to filter out the toxic-gas mixed in the hydrogen-gas, which could avoid the adsorption-saturation situation occurring during filtration in a physical adsorption way and could improve the filtering effect. In addition, the hydrogen-gas generated by the hydrogen-generating device would pass through the water-vapor filter unit and then pass through the filtering assembly of the toxic-gas filter unit, which could avoid reducing the reaction efficiency between the hydroxyls and the toxic-gas due to excess water-vapor adsorbed by the surface of the filtering assembly.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A hydrogen-generating equipment, comprising:
a hydrogen-generating device, capable of generating a hydrogen-gas, a water-vapor mixed in the hydrogen-gas and a toxic-gas mixed in the hydrogen-gas; and
a hydrogen-purifying device, comprising:
a water-vapor filter unit, wherein the hydrogen-gas passes through the water-vapor filter unit to remove the water-vapor mixed in the hydrogen-gas; and
a toxic-gas filter unit, comprising a filtering assembly, wherein a surface of the filtering assembly has a plurality of hydroxyls, after the hydrogen-gas passes through the water-vapor filter unit and when the hydrogen-gas passes through the toxic-gas filter unit, the toxic-gas mixed in the hydrogen-gas reacts with the plurality of hydroxyls to remove the toxic-gas.

2. The hydrogen-generating equipment as claimed in claim 1, wherein the toxic-gas is diborane.

3. The hydrogen-generating equipment as claimed in claim 2, wherein the toxic-gas reacts with the plurality of hydroxyls to generate boron-oxygen bond.

4. The hydrogen-generating equipment as claimed in claim 1, wherein the water-vapor filter unit comprises absorbent cotton fiber mixed with an absorbent organic material or absorbent cotton fiber mixed with an absorbent inorganic material.

5. The hydrogen-generating equipment as claimed in claim 1, wherein the water-vapor filter unit comprises polyacrylate, polyvinyl alcohol, ethylene vinylacetate copolymer, polyurathane, polyethylene oxide, starch branch copolymers, rubber mixture, or a combination of at least two of polyacrylate, polyvinyl alcohol, ethylene vinylacetate copolymer, polyurathane, polyethylene oxide, starch branch copolymers, and rubber mixture.

6. The hydrogen-generating equipment as claimed in claim 1, wherein the water-vapor filter unit comprises aluminosilicate crystal, calcium chloride, calcium oxide, anhydrous cobalt chloride, anhydrous copper sulfate, silica gel, clay or a combination of at least two of aluminosilicate crystal, calcium chloride, calcium oxide, anhydrous cobalt chloride, anhydrous copper sulfate, silica gel, and clay.

7. The hydrogen-generating equipment as claimed in claim 1, wherein the water-vapor filter unit comprises a cooling assembly, the hydrogen-gas is cooled by the cooling assembly so as to condense the water-vapor mixed in the hydrogen-gas.

8. The hydrogen-generating equipment as claimed in claim 1, wherein the filtering assembly comprises a porous structure.

9. The hydrogen-generating equipment as claimed in claim 1, wherein the filtering assembly comprises activated carbon, alumina, zeolite, molecular sieve or a combination of at least two of activated carbon, alumina, zeolite, and molecular sieve.

10. The hydrogen-generating equipment as claimed in claim 1, wherein a surface of the filtering assembly has a single-layer of water molecules for providing the plurality of hydroxyls.

11. The hydrogen-generating equipment as claimed in claim 1, wherein the hydrogen-purifying device comprises a tube structure, the water-vapor filter unit and the toxic-gas filter unit are disposed in the tube structure, and the hydrogen-gas passes through the tube structure so as to pass through the water-vapor filter unit and the toxic-gas filter unit sequentially.

12. The hydrogen-generating equipment as claimed in claim 1, wherein a solid reactant reacts with an acid water solution in the hydrogen-generating device to generate the hydrogen-gas, the water-vapor mixed in the hydrogen-gas, and the toxic-gas mixed in the hydrogen-gas.

13. The hydrogen-generating equipment as claimed in claim 12, wherein the solid reactant comprises a solid hydride, and the solid hydride comprises at least one of sodium borohydride, sodium hydride, lithium borohydride, lithium hydride, calcium hydride, calcium borohydride, magnesium borohydride, potassium borohydride, aluminum borohydride, ammonia borane, diborane diammoniate, polyaminoborane, borazine, borane-morpholine complex, borane-tetrahydrofuran complex, and diborane.

14. The hydrogen-generating equipment as claimed in claim 12, wherein the acid water-solution comprises citric acid, malic acid, oxalic acid, acetic acid, tartaric acid, succinic acid, lactic acid, hydrochloric acid, sulfuric acid, or nitric acid.
